(19) United States
(12) Patent Application Publication
(10) Pub. No.: US 2009/0299876 A1
(43) Pub. Date: Dec. 3, 2009

(54) Method and apparatus for conducting unsolicited trades using personal computers or handheld devices over cellular networks and the internet

(76) Inventors: Peter Loc, Cupertino, CA (US); Holly Pham, Cupertino, CA (US)

Correspondence Address: Peter Loc, 10225 Glencoe Drive, Cupertino, CA, 95014, US

(21) Appl. No.: 12/187,586

(22) Filed: Aug. 7, 2008

Related U.S. Application Data
(60) Provisional application No. 61/057,904, filed on Jun. 2, 2008.

(51) Int. Cl. G06Q 30/00; H04M 3/42

(52) U.S. Cl. 705/27; 455/414.1

(57) ABSTRACT

A method and apparatus to enable subscribers of cellular or telephone networks and internet users to conduct unsolicited and direct trading of goods, offering or requesting services, searching for friends, obtaining or providing specific pieces of information using handheld and personal devices that include smart phones, personal digital assistants, video devices, desktops and laptops.

### CROSS-REFERENCE TO RELATED APPLICATIONS

This application claims the benefit of U.S. Provisional Patent Application Ser. No. 61/057,904 entitled “Method and apparatus for conducting unsolicited trades using personal computers or hand held devices over the internet or computer networks,” filed Jun. 2, 2008, the disclosure thereof incorporated by reference herein in its entirety.

### BACKGROUND

Traditional methods of selling products via the internet require sellers to place advertisements on selected websites and then wait for interested parties to contact them via e-mails or telephone calls. Since there is no mechanism available to pre-screen interested parties, sellers usually receive many inquiries on their items for sale but the percentage of people who are actually interested in buying is usually low. The same process applies to people who have services to offer via the internet.

There are a few undesirable aspects of selling products on the internet:

The seller's contact address is exposed to everyone who reads the advertisement and the seller continues to receive inquiries from individuals even after the product has already been sold.

Traditional methods of buying goods via the internet require buyers to access various websites and scan advertisements to search for products that match their needs. In most cases, buyers tend to spend a great deal of time on the internet but do not find the product they want to purchase.

It is also considered a nuisance to buyers who reach sellers only to find out that products have already been sold or their e-mails to sellers received no responses.

For applications such as property rental, friend searching, looking for roommates etc., internet users usually register with websites that offer these services. However, most of these websites usually require internet users to provide their personal data before granting them membership and access to their database. In general, users have found that individual websites that offer these kinds of services contain only small databases and thus, users need to sign up with several of these services to ensure satisfactory coverage.

There are services on the internet that offer sports scores, breaking and developing news, weather reports, etc. To obtain comprehensive coverage, internet users usually register with many websites, but this can become costly and the amount of information is usually overwhelming. There are very limited options available to users for filtering out unwanted information.

### SUMMARY

In general, the invention presents a method and apparatus to enable anyone who has access to a cellular network or the internet to sell or buy goods, offer or request services, search for friends, or perform unsolicited exchange of information without having to advertise their products or services or perform frequent searches on various websites.

With this invention, cell phone network subscribers or internet users are able to keep their identities and contact addresses only known to those with common interests while remaining anonymous to other internet users when selling or offering services over the cellular network or the internet

The invention provides a means for cell phone network subscribers or internet users to search for friends over various cellular networks or across the internet without having to sign up for membership with groups or organizations running commercial websites.

The method and apparatus of the invention is particularly useful for cell phone network subscribers or internet users who want to seek specific and instantaneous information on weather, sports scores, breaking news etc. without needing to sign up for services from various websites. The information and updates are supplied from other subscribers of the cellular network or internet users but it can come from a website that sends unsolicited updates.

### DESCRIPTION OF DRAWINGS

FIG. 1 shows a conventional system whereby subscribers of a cellular or telephone network may access specific internet websites to buy or sell goods using their handheld devices or cell phones with video display interfaces.

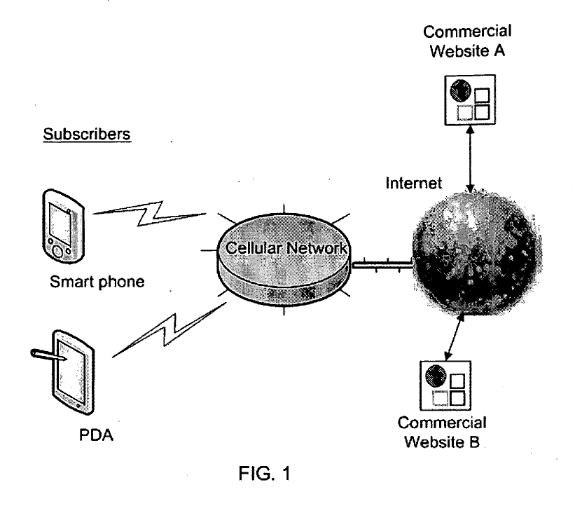

FIG. 2 shows a conventional system whereby users may access the internet via Digital Subscriber Lines (DSLs), cable modems or a wireless service (such as WiMAX) or Wi-Fi.

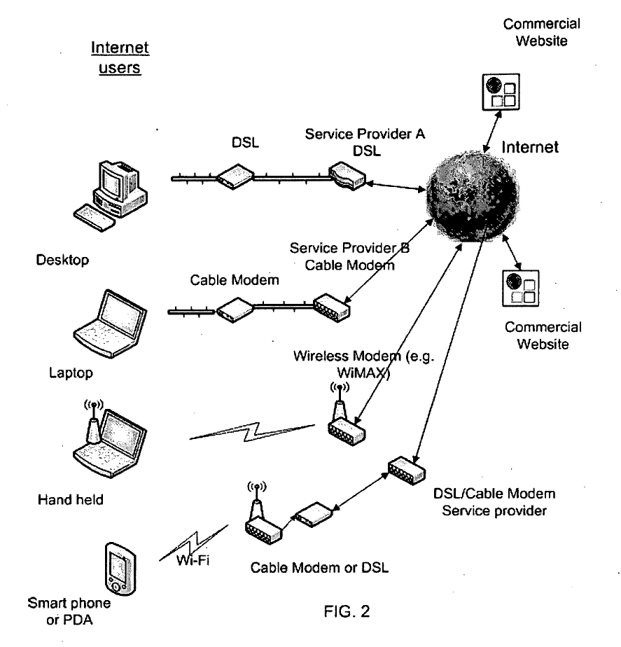

FIG. 3 shows a typical cellular network as shown in FIG. 1 with a presence of a HOST server that connects to the cellular network to support the method and apparatus of the invention. To expand coverage, HOST servers that serve different cellular networks can be linked together via high speed data links to share their databases.

FIG. 4 shows the internet with various devices accessing the internet as shown in FIG. 2 with a presence of a HOST server to support the method and apparatus of the invention. There may be one or more HOST servers that connect to the internet to support the method and apparatus of the invention.

FIG. 5 shows the search routine that the HOST server uses to search for matching templates.

Table 1 shows an example of a “selling” template for sellers to describe their products for sale. This template and subsequent templates are shown herein for illustrative purposes only. An implementation may add or delete fields, change optional values for each field to suit its purpose, but it still remains within the spirit of the invention.

Table 2 shows an example of a “buying” template for buyers to describe products to purchase.

Table 3 shows an example of an “offer service” template for offering a service.

Table 4 shows an example of a “request service” template for requesting a service.

Table 5 shows an example of a “search for friend” template for searching for friends.

Table 6 shows an example of an “information” template.

### DETAILED DESCRIPTION

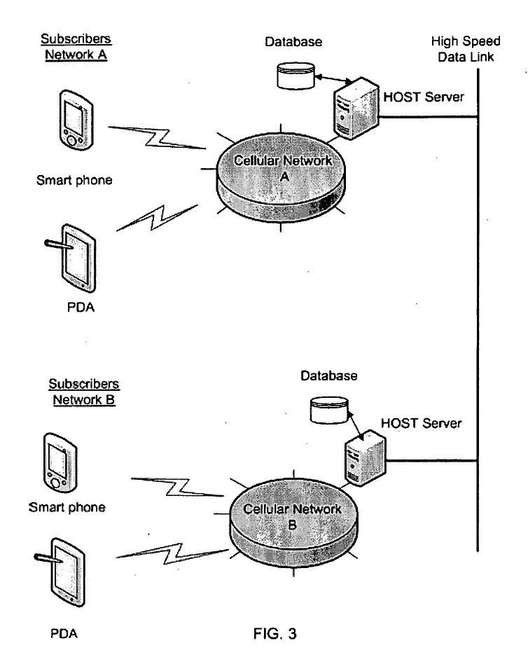

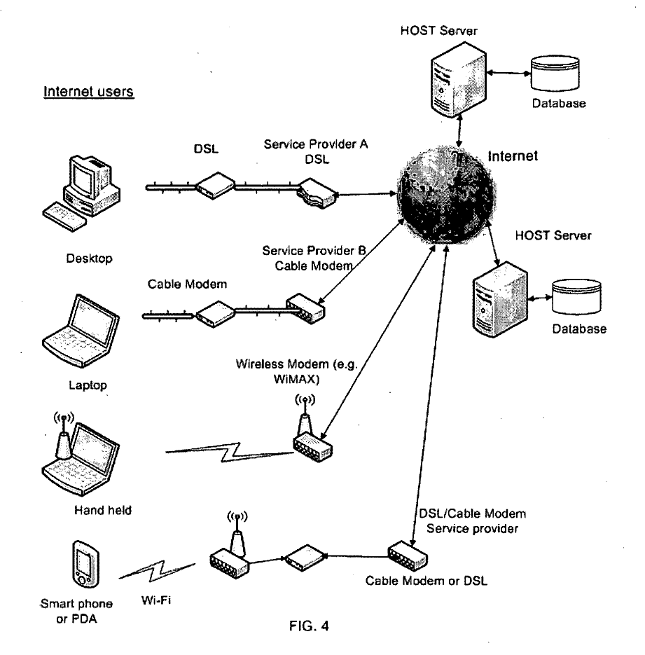

In one embodiment, the invention provides a method and apparatus to enable cell phone network subscribers or internet users to sell products without having to place advertisements on any commercial websites. Anyone with access to a cellular network or the internet can autonomously generate a template that describes a brief but essential detail of the product they want to sell. The template is then transmitted a HOST server that connects to the cellular network or the internet (FIG. 3 and FIG. 4). A typical “selling” template is shown in Table 1.

With the availability of smart phones and powerful handheld devices, the invention provides a means for cell phone network subscribers to submit “selling” templates from anywhere without having access to the internet.

In another embodiment, the invention provides a method and apparatus to enable cell phone network subscribers or internet users to buy products without having to search for products on numerous commercial websites. Anyone with access to a cellular network or the internet can autonomously generate a template that describes a brief but essential detail of the product they want to buy. The template is then transmitted to a HOST server that connects to a cellular network or the internet (FIG. 3 and FIG. 4). A typical “buying” template is shown in Table 2.

This feature is particularly useful for cell phone network subscribers who are traveling and have limited or no access to the internet.

In another embodiment, the invention provides a method and apparatus to enable cell phone network subscribers or internet users to offer specific services without having to place advertisements on commercial websites. Anyone with access to a cellular network or the internet can autonomously generate a template that describes a brief but essential detail of the service they are offering. The template is then transmitted a HOST server that connects to a cellular network or the internet (FIG. 3 and FIG. 4). A typical “offer service” template is shown in Table 3.

In another embodiment, the invention provides a method and apparatus to enable cell phone network subscribers or internet users to request specific types of services without having to search numerous commercial websites looking for similar types of services offered by other internet users. Anyone with access to a cellular network or the internet can autonomously generate a template that describes a brief but enough detail of the service they are requesting. The template is then transmitted to a HOST server that connects to a cellular network or the internet (FIG. 3 and FIG. 4). A typical “request service” template is shown in Table 4.

In a further embodiment, this invention provides a method and apparatus to enable cell phone network subscribers or internet users to look for friends without having to search numerous commercial websites or join any organizations that dedicate to the search for friend business. Anyone with access to a cellular network or the internet can autonomously generate a template that describes a brief but sufficient detail of the friend they are looking for. The template is then transmitted a HOST server that connects to a cellular network or the internet (FIG. 3 and FIG. 4). A typical “look for friend” template is shown in Table 5.

In yet another embodiment, the invention provides a method and apparatus to enable cell phone network subscribers or internet users to obtain specific information without having to search numerous commercial websites all the time.

Users generate “information” templates (FIG. 6) to request or provide specific information regarding any events that are currently taking place, for examples, changing weather in a city, the score of an ongoing football game, a sale at a well-known department store etc. or even opinion regarding a recent TV show, a newly released movie etc. The “information” template is particularly useful for cellular phone users who can get the information while on-the-go with limited or no access to the internet.

The main function of the HOST server is to find a match between a receiving template and the templates that are currently stored in its database, based on their types and categories. For example, the HOST receives a “buying” template (see Table 2); it would retrieve all “selling” templates currently stored in its database to look for a match.

If a match is found, the HOST server sends notifications to both submitters of the matching templates and exchanges contact addresses. It is then up to both submitters to further the trade. It is possible to have multiple matches to one template.

The HOST server stores the arriving template in its database if a match is not found.

Every template has a default expiration time. Submitters may set this time to be shorter than default. The HOST server will discard a template when its expiration time is reached. A template may also be discarded from the HOST server database if the submitter sends to the HOST server a cancellation request before its expiration time is reached.

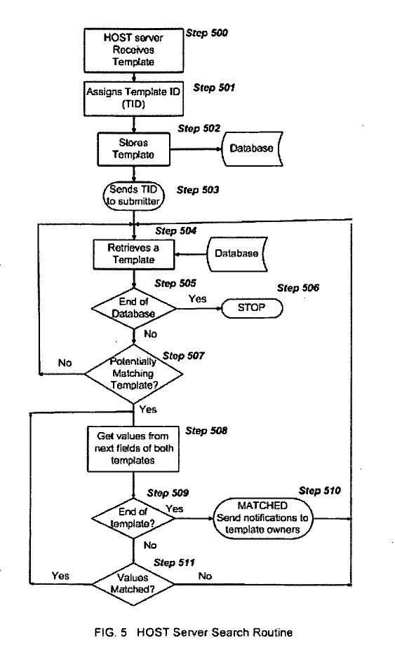

FIG. 5 shows the search routine that a HOST server uses to search for one or more matching templates. The HOST server receives a template (step 500), assigns a template ID (TID) (step 501), stores the template in its database (step 502) and sends a confirmation message to the submitter of the template with the assigned TID (step 503).

Depending on the type of the received template, the HOST server retrieves all potentially matching templates one by one from its database to check against the received template for a match. For example, if a template with the type specified as “buying” is received, all templates with the types of “selling” are considered potentially matching templates and will be checked, field by field, against the received template.

The HOST server retrieves a template from its database (step 504). If successful (step 505), it checks if the retrieved template (step 507) is a potentially matching template by checking the type.
If the retrieved template is not a potentially matching template, the HOST server goes back to step 504 to retrieve the next template. If the end of the database is reached, the HOST server will stop searching and wait for the next template to arrive (step 506).
If the retrieved template is a potentially matching template, the HOST server will proceed to compare the values in the corresponding fields of the received and retrieved templates (steps 508, 509 and 511). Step 508 retrieves values of the next fields from both templates, Step 509 checks for end of template, step 511 compares the values of the fields. If the values are equivalent, the check continues until the end of template is reached and the templates are declared as “matched” (step 510). If a pair of values failed step 511, the HOST server discards the retrieved template and goes back to step 504 to retrieve the next potentially matched template.

The search routing shown in FIG. 5 may result in multiple matches to a receiving template.

A number of implementations of the invention have been described. Nevertheless, it should be understood that various modifications may be made without departing from the spirit and scope of the invention. Accordingly, other implementations may be found to be within the scope of the following claims.

TABLE 1
Example of a “selling” template

Type: selling
Category: automobile, consumer electronics, games, etc.
If automobile is selected:
Make: Honda, Toyota, Ford, GMC, Mazda, Porsche, etc.
Model: Accord, Camry, Taurus, Pontiac etc.
Model year: xxxx
Color: red/blue/green/yellow/etc . . .
Miles: xxxxxx
Condition: fair/good/excellent/drivable/not drivable
Price: ($) xxxxx or negotiable
Contact phone: xxx-xxx-xxxx
Call restriction: day, night or none
Contact email address: xxxxx@xxx.com or none
Time to keep template active: 1, 2, 3, . . . (days) or (weeks)

TABLE 2
Example of a “buying” template

Type: buying
Category: automobile, consumer electronics, games, etc..
If automobile is selected:
Make: Honda, Toyota, Ford, GMC, Mazda, Porsche, etc..
Model: Accord, Camry, Taurus, Pontiac etc..
Model year: xxxx or don't care
Color: red/blue/green/yellow/etc . . . or don't care
Miles: 0, 12000, 30000 etc.. or don't care
Condition: fair/good/excellent drivable or don't care
Price: ($) xxxxx or less or negotiable
Contact phone: xxx-xxx-xxxx
Call restriction: day, night or none
Contact email address: xxxxx@xxx.com or none
Time to keep template active: 1, 2, 3, . . . (days) or (weeks)

TABLE 3
Example of an “offer service” template

Type: offer service
Category: building and construction, landscaping, carpentry, car wash,
baby sitting etc . . .
If building and construction is selected:
Structure: home, room, bath room, kitchen, foundation, general
Contractor license: registered or don't care
Contract size: ($) less than 1000, 2000, 5000 etc.. or not specified
Contact phone: xxx-xxx-xxxx
Call restriction: day, night or none
Contact email address: xxxxx@xxx.com
Time to keep template active: 1, 2, 3, . . . (hours) or (days)

TABLE 4
Example of a “request service” template

Type: request service
Category: building and construction, landscaping, carpenting, car wash,
baby sitting etc . . .
If building and construction is selected:
Structure: home, room, bath room, kitchen, foundation, general
Contractor license: registered or don't care
Contract size: ($) 1000, 2000, 5000 or more etc.. or not specified
Contact phone: xxx-xxx-xxxx
Call restriction: day, night or none
Contact email address: xxxxx@xxx.com
Time to keep template active: 1, 2, 3, . . . (hours) or (days)

TABLE 5
Example of a “search for friend” template

Type: looking for a friend
Category: old friend or new friend
If old friend is selected:
Person's name: specific name (John Doe) or blank
College attended: name of the school or leave blank to
search for high school or elementary school attended
High School attended: name of the school or leave
blank to search for college or elementary school attended
Elementary School attended: name of the school or
leave blank to search for college or elementary school attended
Year of graduation: year (from college, high school or
elementary)
Contact phone: xxx-xxx-xxxx
Call restriction: day, night or none
Contact email address: xxxxx@xxx.com
Time to keep template active: 1, 2, 3, . . . (hours) or
(days)

TABLE 6
Example of an “information” template

Type: obtain information, provide information
Category: weather change, sports score, TV show
rating, movie, department sale
If weather change is selected:
Place: City or Zip Code
Information: raining, sunny, stormy weather, cold, hot
Message: address of sender or a greeting or blank
Time to keep template active: 1, 2, 3, . . . (hours) or
(days)

What is claimed is:

1. A method and apparatus to enable subscribers of a cellular or telephone network to trade goods, request or offer services, search for friends, obtain or provide specific pieces of information comprises:
handheld devices that include smart phones, personal digital assistants, and video/audio personal devices with access to a cellular or telephone network, and
a HOST server connects to the cellular or telephone network to perform matching function.

2. The method and apparatus of claim 1, wherein subscribers who have items of goods to sell or buy, from their handheld devices, enter descriptions of those items and submit them to the HOST server via the cellular or telephone network.

3. The method and apparatus of claim 1, wherein subscribers of a cellular or telephone network have services to offer or request, from their handheld devices, enter descriptions of those services and submit them to the HOST server via the cellular or telephone network.

4. The method and apparatus of claim 1, wherein subscribers of the cellular or telephone network are searching for friends, from their handheld devices, enter descriptions of their friends and submit them to the HOST server via the cellular or telephone network.

5. The method and apparatus of claim 1, wherein subscribers of the cellular or telephone network are requesting specific pieces of information, from their handheld devices, enter descriptions of the information requested and submit them to the HOST server via the cellular or telephone network.

6. The method and apparatus of claim 1, wherein subscribers of the cellular or telephone network are providing specific pieces of information, from their handheld devices, enter descriptions of the information and submit them to the HOST server via the cellular or telephone network.

7. The method and apparatus of claim 1, wherein the HOST server provides templates for subscribers to enter data.
Subscribers use these templates to fill in descriptions of items for sale or purchase, services to offer or request, friends to look for or specific pieces of information to request or provide.
Each template has an expired time field that has to be filled in by subscribers.

8. The method and apparatus of claim 1, wherein the HOST server receives a template from a subscriber, stores it in its database, assigns an ID to the received template (TID), sends the TID to the submitter of the template and begins checking against all other templates that are currently stored in its database for a match.

9. The Host server of claim 8 finds a matching template and sends notifications to the submitters of the matched templates, exchanges their contact addresses.

10. The Host server of claim 1 discards a template when the expiration time of the template is reached or when a cancellation request with a valid TID is received.

11. The method and apparatus of claim 1, wherein the HOST server can be connected to other HOST servers by high speed data links to share databases.

12. A method and apparatus to enable internet users to trade goods, offer or request services, search for friends and requesting or providing specific information comprises:
personal devices that include personal computers, laptops, smart phones, personal digital assistants, video/audio personal devices with access to the internet, and
a Host server connects to the internet to perform matching function.

13. The method and apparatus of claim 12, wherein internet users who have items of goods to sell or buy, from their personal devices, enter descriptions of those items and submit them to a HOST server via the internet.

14. The method and apparatus of claim 12, wherein, internet users have services to offer or request, from their personal devices, enter descriptions of those services and submit them to a HOST server via the internet.

15. The method and apparatus of claim 12, wherein internet users are searching for friends, from their personal devices, enter descriptions of their friends and submit them to the HOST server via the internet

16. The method and apparatus of claim 12, wherein internet users are requesting specific pieces of information, from their personal devices, enter descriptions of the information they are seeking on templates and submit them to the HOST server via the internet.

17. The method and apparatus of claim 12, wherein internet users are providing specific pieces of information, from their personal devices, enter descriptions of the information on templates and submit them to the HOST server via the internet.

18. The method and apparatus of claim 12, wherein the HOST server provides templates for internet users to enter descriptions of items to sell or buy, offer or request services, search for friends, requesting or providing specific information.
Each template has an expired time field that has to be filled in by subscribers.

19. The method and apparatus of claim 12, wherein the HOST server receives a template from an internet user, stores it in its database, assigns an ID to the received template (TID), sends the TID to submitter of the template, and begins checking against all other templates that are currently stored in its database for a match.

20. The HOST server of claim 19, finds a matching template, sends notifications to the contact addresses as shown in the two matched templates and exchanges their addresses.

21. The Host server of claim 12, discards a template when the expiration time of the template is reached or when a cancellation request with a valid TID is received

22. A method and apparatus to enable users of a private computer network to trade goods, offer or request services, search for friends, request or provide specific pieces of information, comprises:
personal devices that include personal computers, laptops, smart phones, personal digital assistants, video/audio personal devices with access to a private computer network, and
a Host server connects to the private computer network to perform matching function.

23. The method and apparatus of claim 22, wherein users of a private computer network, have items of goods to sell or buy, from their personal devices, enter descriptions of those items and submit them to a HOST server via the private computer network.

24. The method and apparatus of claim 22, wherein users of a private computer network, have services to offer or request, from their personal devices, enter descriptions of those services and submit them to a HOST server via the private computer network.

25. The method and apparatus of claim 22 wherein users of a private computer network are searching for friends, from their personal devices, enter descriptions of their friends and submit them to the HOST server via the private computer network.

26. The method and apparatus of claim 22, wherein users of a private computer network are requesting specific pieces of information, from their personal devices, enter descriptions of the information they are seeking and submit them to the HOST server via the private computer network.

27. The method and apparatus of claim 22, wherein users of a private computer network are providing specific pieces of information, from their personal devices, enter descriptions of the information and submit them to the HOST server via the private computer network.

28. The method and apparatus of claim 22, wherein the HOST server provides templates for users of a private computer network to enter descriptions of items for sale or purchase, services offer or request, friends to search for, requesting or providing specific pieces of information.
Each template has an expired time field that has to be filled in by subscribers.

29. The method and apparatus of claim 22, wherein the HOST server receives a template from users of a private computer network, stores it in its database, assigns an ID to the received template (TID), sends the TID to submitter of the template, and begins checking against all other templates that are currently stored in its database for a match.

30. The HOST server of claim 29, finds a matching template, sends notifications to the contact addresses as shown in the two matched templates and exchanges their addresses.

31. The Host server of claim 22, discards a template when the expiration time of the template is reached or when a cancellation request with a valid TID is received

32. The method and apparatus of claim 22, wherein the HOST server can be connected with other HOST servers by high speed data links to share databases.
